(19) United States
(12) Patent Application Publication
(10) Pub. No.: US 2012/0231272 A1
(43) Pub. Date: Sep. 13, 2012

(54) COMPRESSIBLE DUAL RESIN THERMOPLASTIC WELDING ROD AND METHOD FOR ELECTRIC RESISTANCE THERMOPLASTIC WELDING

(75) Inventor: Robert Pinder, Chelsea (CA)

(73) Assignee: POWERCORE INTERNATIONAL LTD., Ottawa (CA)

(21) Appl. No.: 13/509,550

(22) PCT Filed: Nov. 10, 2010
(86) PCT No.: PCT/CA10/01791

§ 371 Date: May 11, 2012

Related U.S. Application Data
(60) Provisional application No. 61/260,153, filed on Nov. 11, 2009.

(51) Int. Cl. B32B 1/00; B32B 37/06; B32B 37/02; B32B 27/08

(52) U.S. Cl. 428/377; 156/272.2; 156/185

(57) ABSTRACT

An innovative method of thermoplastic electrofusion welding uses a novel compressible dual resin thermoplastic welding rod. This welding rod comprises an inner core made of a soft first thermoplastic resin, a resistance wire wrapped around the inner core, and an outer coating surrounding the inner core and wire. The outer coating is made of a second thermoplastic resin that is harder than the first thermoplastic resin of the inner core. The first thermoplastic may be made of thermoplastic vulcanizate (TPV). The second thermoplastic resin may be made of a high-density polyethylene (HDPE). Because of its compressibility, this dual resin electrofusion welding rod greatly facilitates the seating of parts that are to be welded together.

### TECHNICAL FIELD

The present invention relates generally to thermoplastic welding and, in particular, to thermoplastic welding using thermoplastic welding rod.

### BACKGROUND

Thermoplastic welding technology enables thermoplastic components to be electrofused, or welded, together.

Some notable improvements in this field of technology are disclosed in U.S. Pat. No. 5,407,520 (Butts et al.) entitled “Welding rod” and in U.S. Pat. No. 5,407,514 (Butts et al.) entitled “Method for welding thermoplastic materials”. These patent disclose an improved welding rod having a solid homogeneous core of thermoplastic material and a resistance element comprised of a plurality of wires. The welding rod is positioned between members of the thermoplastic material to be welded and a current and pressure is applied to the resistance element causing the thermoplastic material of the solid core and the adjacent thermoplastic members to fuse and form a unitary weld. Simultaneously the electrical resistance element is embedded in the weld, mechanically reinforcing and strengthening the connection. These patents also disclose a method for electric fusion welding of thermoplastic members wherein the welding rod is pre-attached to one of the thermoplastic members.

One problem that has arisen in the use of homogenous electrofusion welding rod (HEWR) is positioning of the rod. Because the HEWR is made of a hard (stiff) thermoplastic resin, the rod may not seat properly between uneven thermoplastic part surfaces to be joined. As a result of imprecise positioning, some of the HEWR may not come into contact with the two parts to be joined, thereby causing localized overheating or an incomplete fusion bond due to imperfect contact.

Furthermore, parts must fit together with close machined tolerances to allow the HEWR to fit between parts prior to welding (when cold) and then must be clamped to ensure contact during the welding process. In some cases, high tolerance machining and clamping is not possible.

For example, large diameter plastic bell and spigot plastic pipe often varies slightly in diameter and roundness, thus resulting in poor contact around the mating surface, i.e. at the interface. This makes fluid-tight seals hard to achieve.

Accordingly, making a good fusion bond using a homogeneous electrofusion welding rod (HEWR) is extremely difficult. This has remained a technical problem for which an adequate solution has, until now, yet to be devised.

### SUMMARY

The present invention provides a novel compressible dual resin electrofusion welding rod (DREWR) and method of welding using this DREWR. The DREWR comprises a soft inner core and a hard outer coating with a resistance wire wrapped around the inner core or otherwise embedded within the outer coating. Due to the soft inner core, the DREWR is easily compressible when cold, unlike conventional HEWR which is not compressible unless heated. Accordingly, the compressible DREWR is able to deform and dimensionally adapt to the surfaces or objects that are to be conjoined, unlike the harder HEWR which, if not seated or positioned precisely, may leave an unwanted gap or space between the surfaces or objects to be joined. The deformability of the rod is made possible by the concentric hard outer coating and soft inner core. For example, the first thermoplastic in the soft inner core may be made of thermoplastic vulcanizate (TPV) while the second thermoplastic resin of the outer coating may be made of a high-density polyethylene (HDPE).

As will be elaborated below, the compressible dual resin electrofusion welding rod enables a novel method of welding thermoplastics. While this novel method may be used in a broad range of applications, it is particularly useful in welding a pipe spigot to a pipe bell.

In accordance with one main aspect of the present invention, a method of thermoplastic welding entails providing a compressible dual resin thermoplastic welding rod having an inner core made of a soft first thermoplastic resin, a resistance wire wrapped around the inner core, and an outer coating surrounding the inner core and wire, the outer coating being made of a second thermoplastic resin that is harder than the first thermoplastic resin of the inner core. The method further involves positioning the welding rod at an interface of two surfaces to join and heating the resistance wire to weld the two surfaces together.

In accordance with another main aspect of the present invention, a compressible dual resin thermoplastic welding rod includes an inner core made of a soft first thermoplastic resin, a resistance wire wrapped around the inner core, and an outer coating surrounding the inner core and wire. The outer coating is made of a second thermoplastic resin that is harder than the first thermoplastic resin of the inner core. In certain embodiments, the first thermoplastic is made of thermoplastic vulcanizate (TPV) while the second thermoplastic resin is made of a high-density polyethylene (HDPE).

In accordance with yet another aspect of the present invention, a method of manufacturing a compressible dual resin thermoplastic welding rod entails providing a substantially cylindrical inner core made of a soft first thermoplastic resin, wrapping a resistance wire around the inner core, and coating the inner core and wire with a second thermoplastic resin that is harder than the first thermoplastic resin of the inner core.

### BRIEF DESCRIPTION OF THE DRAWINGS

Further features and advantages of the present technology will become apparent from the following detailed description, taken in combination with the appended drawings, in which:

FIG. 1 is a front view of a homogenous electrofusion welding rod (HEWR);

FIG. 2 is a front view of the same HEWR, depicting substantial resistance to compression or deformation when cold;

FIG. 3 is a cross-sectional view of a pipe spigot misaligned within a pipe bell and the resulting gap that is likely to be created when using the generally incompressible HEWR;

FIG. 4 is a front view of a dual resin electrofusion welding rod (DREWR) in accordance with embodiments of the present invention;

FIG. 5 is a front view of the same DREWR, depicting its cold-state compressibility;

FIG. 6 is a cross-sectional view of a pipe spigot misaligned within a pipe bell, depicting how the compressible dual resin electrofusion welding rod compensates for the misalignment by deforming to the non-uniform annular gap between the spigot and the bell;

FIG. 7 is a flowchart depicting steps of a method of thermoplastic welding in accordance with embodiments of the present invention; and

FIG. 8 is a flowchart depicting steps of a method of manufacturing a compressible dual resin thermoplastic welding rod in accordance with embodiments of the present invention.

It will be noted that throughout the appended drawings, like features are identified by like reference numerals.

### DETAILED DESCRIPTION

In general, and by way of overview, the present invention is directed to a compressible dual resin electrofusion welding rod and a method of using this rod to perform thermoplastic welding. A method of manufacturing this novel dual resin electrofusion welding rod is also disclosed herein.

### DUAL RESIN ELECTROFUSION WELDING ROD (DREWR)

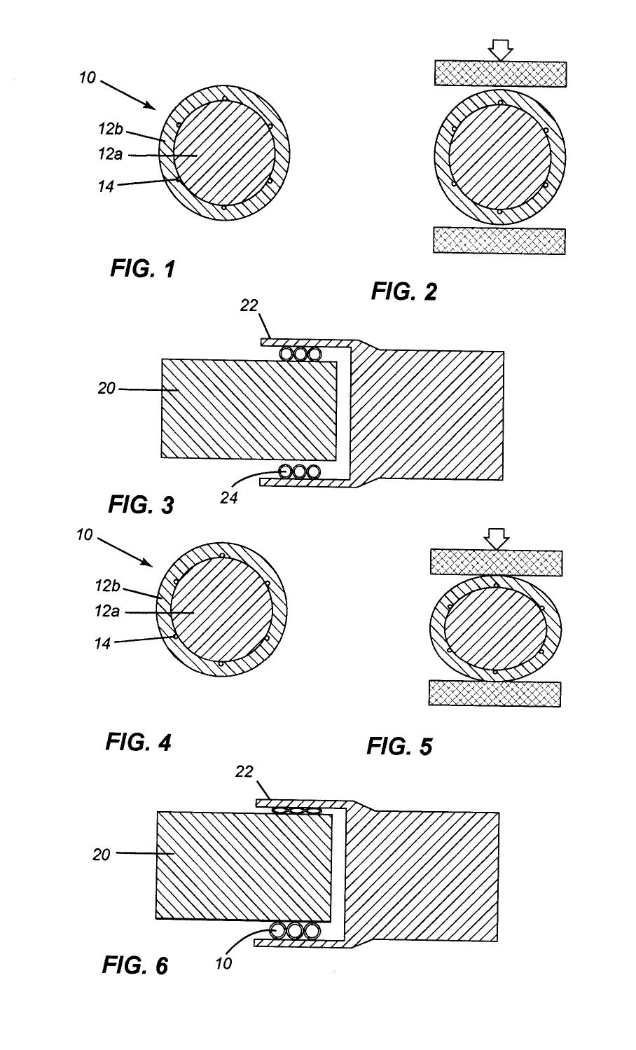

As depicted by way of example in FIG. 4, a novel compressible dual resin electrofusion welding rod (DREWR), also referred to herein as a “compressible dual resin thermoplastic welding rod” or simply as the “welding rod”, is generally designated by reference numeral 10. This dual resin welding rod 10 includes an inner core 12 made of a soft first thermoplastic resin. The DREWR also includes a resistance wire 14 wrapped around the inner core and an outer coating 16 surrounding the inner core and wire. The outer coating is made of a second thermoplastic resin that is harder than the first thermoplastic resin of the inner core. As shown in FIG. 5, the dual resin welding rod is compressible even when cold, unlike its homogeneous (single resin) counterpart (depicted in FIG. 1) which not compressible when cold, as shown in FIG. 2. In other words, in the conventional homogeneous welding rod depicted in FIG. 1 and FIG. 2, both the inner core 12a and the outer coating 12b are made of the same thermoplastic material.

In one embodiment, the first thermoplastic resin is thermoplastic vulcanizate (TPV). In one embodiment, the second thermoplastic resin is high-density polyethylene (HDPE). In the best mode known to Applicant as of the time of filing this application, the welding rod is made of thermoplastic vulcanizate (TPV) in the inner core and high-density polyethylene (HDPE) for the outer coating.

As will be appreciated, other resins may be substituted to achieve similarly beneficial effects.

As shown in the figures, the welding rod has a relatively thin annular outer coating that is smaller in dimension than the radius of the inner core. In other words, a radius of the inner core is greater than an annular thickness of the outer coating.

### METHOD OF THERMOPLASTIC WELDING

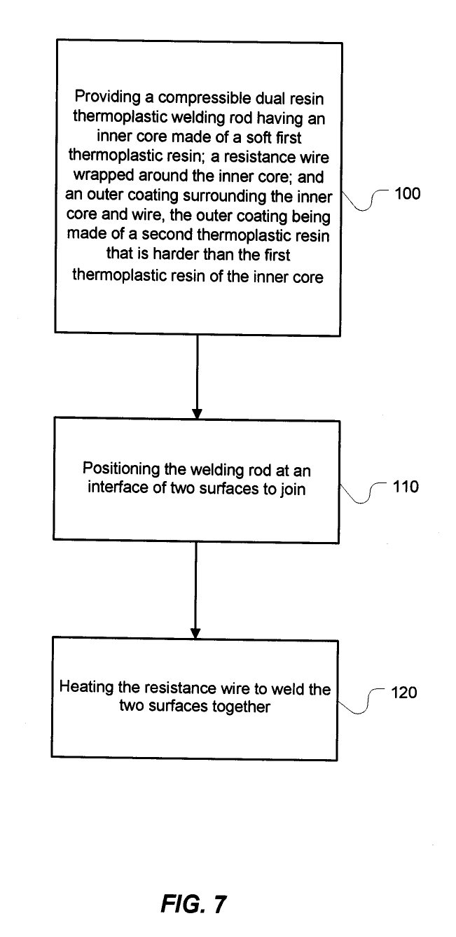

The novel dual resin electrofusion welding rod disclosed in this application enables an innovative method for thermoplastic welding. As depicted in the flowchart presented in FIG. 7, this innovative method entails a step 100 of providing a compressible dual resin thermoplastic welding rod having an inner core made of a soft first thermoplastic resin, a resistance wire wrapped around the inner core and an outer coating surrounding the inner core and wire, the outer coating being made of a second thermoplastic resin that is harder than the first thermoplastic resin of the inner core. The method then involves a step 110 of positioning the welding rod at an interface of two surfaces to join and then (at step 120) heating the resistance wire to weld the two surfaces together.

This method can be applied to a broad range of thermoplastic welding applications. One such application where this novel technology is especially useful is in the context of welding pipes, particularly pipe spigots to pipe bells as shown by way of example in FIG. 6. Welding a pipe spigot 20 to a respective pipe bell 22 is technically difficult using the conventional HEWR 24 because this rigid, generally non-pliable, non-malleable rod does not deform or adapt to the imperfections of the pipe spigot or pipe bell. This is depicted in FIG. 3. Clamping (not shown but well understood in the art) is sometimes necessary to ensure a proper weld. In contrast, as depicted in FIG. 6, the novel technology disclosed herein provides a deformable (malleable, pliable) dual resin welding rod 26 that conforms to the dimensional imperfections of the pipe spigot 20 and pipe bell 22, thereby providing a much better weld and a much more solid and reliable fluid-tight seal. As shown in FIG. 6, the welding rod is positioned in an annular gap between an outer diameter of a pipe spigot and an inner diameter of a pipe bell. Even if the pipe spigot is improperly aligned relative to the pipe bell as depicted in FIG. 6, the compressible nature of this dual resin welding rod compensates for this misalignment and provides for a good seal.

### METHOD OF MANUFACTURING THE DREWR

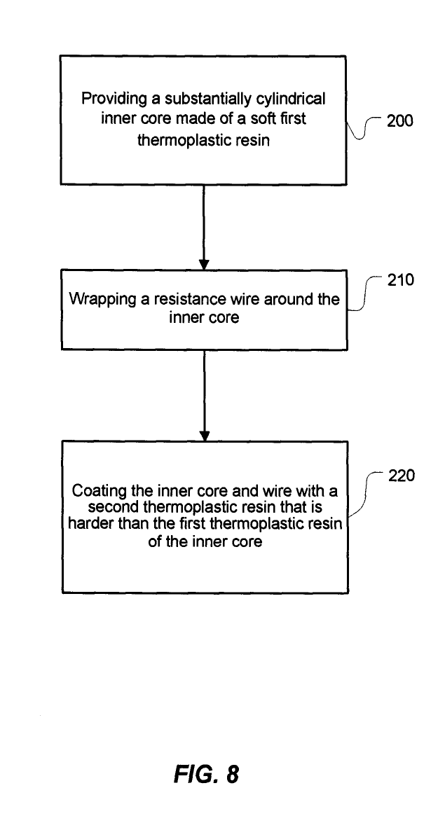

As depicted in the flowchart presented in FIG. 8, this novel compressible dual resin thermoplastic welding rod may be manufactured according to the following method: first, at step 200, a substantially cylindrical inner core made of a soft first thermoplastic resin is produced (moulded and/or machined) to the correct diameter and length. Then, at step 210, this inner core is wrapped with a resistance wire of a suitable gauge and cut to an appropriate length. Finally, at step 220, the inner core and wire are encapsulated in an outer (annular) coating made of a second thermoplastic resin that is harder than the first thermoplastic resin of the inner core. As noted above, the first thermoplastic resin may be thermoplastic vulcanizate (TPV) and the second thermoplastic resin may be high-density polyethylene (HDPE), although other materials may be substituted as will be appreciated by those of ordinary skill in the art.

As will be appreciated by those of ordinary skill in the art, many refinements and modifications may be made to this novel technology without departing from the inventive concept(s) presented herein.

For example, the welding rod may have an additional middle annular band, thus effectively creating a triple resin electrofusion welding rod (with an inner core made of a first resin, a middle annular band made of a second resin and an outer coating made of a third resin.

Another possible variation, the inner core could be hollow, i.e. the inner core rather than being a solid cylinder could be tubular with an axial air gap extending along the central axis. As another possible variation, the inner core could be removed altogether such that the welding rod is tubular in construction and is composed solely of one annular resin component. Even if the annular resin component is hard/stiff HDPE, it would be compressible because it is annular and has no internal core.

Another variant would be to put the HDPE in the inside (as the inner core) and the PVT on the outside (as the outer coating).

In another embodiment, both the inner core and outer coating could be made of the same (or similar) compressible material, e.g. both the inner core and the outer coating could be made of TPV. In one specific embodiment, the outer coating may be made of a harder TPV than the inner core.

In addition, this novel dual resin rod can be made into a cylindrical coil to create a wide fusion bond (as in the bell and spigot drawing shown in FIG. 6) whereas a compression gasket has to be made into a single ring.

Another innovative aspect of this technology is that two coils may be placed in a bell to create a sealed air void between the two, once welded. In this manner, an air pressure test can be performed when assembling the pipe to ensure that there is a good seal. This can all be accomplished from the outside with simple tools, something that is impossible now with pre-existing technology.

Although there are a number of possible variations, the dual resin welding rod with the solid inner core of PVT and outer coating of HDPE that has been described above is believed to be the best overall solution and the most cost-effective. The variants are presented solely to illustrate the broad applicability of the inventive concept(s) presented herein.

The embodiments of the invention described above are intended to be exemplary only. As will be appreciated by those of ordinary skill in the art, to whom this specification is addressed, many obvious variations can be made to the embodiments present herein without departing from the spirit and scope of the invention. The scope of the exclusive right sought by the applicant is therefore intended to be limited solely by the appended claims.

1. A method of thermoplastic welding, the method comprising:
providing a compressible dual resin thermoplastic welding rod having:
an inner core made of a soft first thermoplastic resin;
a resistance wire wrapped around the inner core; and
an outer coating surrounding the inner core and wire, the outer coating being made of a second thermoplastic resin that is harder than the first thermoplastic resin of the inner core; and
positioning the welding rod at an interface of two surfaces to join; and
heating the resistance wire to weld the two surfaces together.

2. The method as claimed in claim 1 wherein positioning comprises positioning the welding rod in an annular gap between an outer diameter of a pipe spigot and an inner diameter of a pipe bell.

3. The method as claimed in claim 1 wherein the first thermoplastic resin is thermoplastic vulcanizate (TPV).

4. The method as claimed in claim 1 wherein the second thermoplastic resin is high-density polyethylene (HDPE).

5. The method as claimed in claim 1 wherein a radius of the inner core is greater than an annular thickness of the outer coating.

6. A compressible dual resin thermoplastic welding rod comprising:
an inner core made of a soft first thermoplastic resin;
a resistance wire wrapped around the inner core; and
an outer coating surrounding the inner core and wire, the outer coating being made of a second thermoplastic resin that is harder than the first thermoplastic resin of the inner core.

7. The welding rod as claimed in claim 6 wherein the first thermoplastic resin is thermoplastic vulcanizate (TPV).

8. The welding rod as claimed in claim 6 wherein the second thermoplastic resin is high-density polyethylene (HDPE).

9. The welding rod as claimed in 6 wherein a radius of the inner core is greater than an annular thickness of the outer coating.

10. A method of manufacturing a compressible dual resin thermoplastic welding rod, the method comprising:
providing a substantially cylindrical inner core made of a soft first thermoplastic resin;
wrapping a resistance wire around the inner core; and
coating the inner core and wire with a second thermoplastic resin that is harder than the first thermoplastic resin of the inner core.

11. The method as claimed in claim 10 wherein the first thermoplastic resin is thermoplastic vulcanizate (TPV).

12. The method as claimed in claim 10 wherein the second thermoplastic resin is high-density polyethylene (HDPE).

13. (canceled)

14. The method as claimed in claim 2 wherein the first thermoplastic resin is thermoplastic vulcanizate (TPV).

15. The method as claimed in claim 2 wherein the second thermoplastic resin is high-density polyethylene (HDPE).

16. The method as claimed in claim 3 wherein the second thermoplastic resin is high-density polyethylene (HDPE).

17. The method as claimed in claim 2 wherein a radius of the inner core is greater than an annular thickness of the outer coating.

18. The welding rod as claimed in claim 7 wherein the second thermoplastic resin is high-density polyethylene (HDPE).

19. The welding rod as claimed in claim 7 wherein a radius of the inner core is greater than an annular thickness of the outer coating.

20. The welding rod as claimed in claim 8 wherein a radius of the inner core is greater than an annular thickness of the outer coating.

21. The method as claimed in claim 11 wherein the second thermoplastic resin is high-density polyethylene (HDPE).
